(19) United States
(12) Patent Application Publication
(10) Pub. No.: US 2002/0082925 A1
(43) Pub. Date: Jun. 27, 2002

(54) Method and apparatus for utilizing a smart card to maintain a retail application on a number of portable, wireless hand-held computing devices

(76) Inventor: Nathaniel C. Herwig, Lawrenceville, GA (US)

Correspondence Address: Paul W. Martin, NCR Corporation, Law Department, ECD-2, 101 W. Schantz Avenue, Dayton, OH, 45479-0001, US

(21) Appl. No.: 09/748,956

(22) Filed: Dec. 27, 2000

(51) Int. Cl. G06F 17/60; G06F 7/08

(52) U.S. Cl. 705/16; 705/17; 705/14; 235/381

(57) ABSTRACT

A retail system includes a smart card for use by a customer. The smart card has a card memory device for maintaining a customer profile associated with the customer. The retail system also includes a retail checkout terminal which includes a first smart card interface device. The first smart card interface device is operable to update the customer profile based on use of the retail checkout terminal by the customer when the smart card is inserted in the first smart card interface device. The retail system yet further includes a portable, wireless hand-held computing device which includes a second smart card interface device. The handheld computing device is configured to perform a customer-specific retail function based on the customer profile when the smart card is inserted in the second smart card interface device. A method of operating a retail system is also disclosed.

### TECHNICAL FIELD OF THE INVENTION

The present invention relates generally to a retail system, and more particularly to a method and apparatus for utilizing a smart card to maintain a retail application on a number of portable, wireless hand-held computing devices.

### BACKGROUND OF THE INVENTION

In the retail industry, it is common for a retailer, such a grocery store or chain of grocery stores, to operate a customer loyalty program. A customer loyalty program is a program which attempts to reward those customers that, for example, frequently shop at the retailer's store and/or those customers which spend large amounts of money at the retailer's store. Such loyalty programs often utilize a marketing strategy commonly referred to as customer-specific marketing. In the case of customer-specific marketing, the retailer attempts to advertise products to individual customers based on the customers previous buying habits. For example, the retailer may utilize a customer-specific marketing strategy to offer a soda coupon to a customer which regularly buys soda, but would offer a different coupon to a customer which does not have a history of buying soda from the retailer.

Customer loyalty programs are typically administered by assigning each customer enrolled in the program a loyalty card. The loyalty card typically has a magnetic strip thereon which may be swiped through a magnetic strip card reader located at a checkout terminal associated with the retailer's operation. The magnetic strip has stored therein a code which identifies the customer by either name or customer number. Once, the card reader has read the customer's name or number from the card, the processing unit associated with the checkout terminal communicates with a customer database in order to retrieve retail history information associated with the customer. For example, such retail history information may include the number of times the customer has shopped in the retailer's store in the previous six months, the dollar amount spent by the customer in the previous six months, a list of each of the items purchased by the customer in the last six months, etcetera. Once the customer's transaction is complete, a record of the customer's transaction, including the total dollar amount of the transaction along with a list of each of the items purchased by the customer, is then stored in the retailer's customer database. It should be appreciated that such a customer database may be maintained locally (i.e. at a single store), regionally (at a site which services the retailer's stores within a given region), or globally (at the retailer's headquarters which services all of the retailer's stores).

Hence, at any given time, the customer database maintains a profile for each of the retailer's customers which includes the customer's retail history information. Periodically, when a given customer's shopping habits meet certain criteria (e.g. the customer spends a requisite amount of money within a given time period), the retailer may decide to reward the customer. The retailer may print a special coupon for the customer or may alternatively print a gift certificate for the customer. It should be appreciated that the coupon or gift certificate may be customized based on the purchasing habits of the customer. For example, a coupon for a free bag of pretzels may be printed for a highly-valued customer that routinely purchases soda from the retailer.

Administration of customer loyalty programs in the manner previously discussed has a number of drawbacks associated therewith. For example, administration of customer loyalty programs in the manner previously discussed undesirably requires the retailer to utilize large, often dedicated, amounts of computing and memory resources to maintenance of the customer database. In particular, the retailer must maintain a large network system in order to track the activity of each customer within the loyalty program. Moreover, use of magnetic strip cards is undesirably susceptible to fraud since magnetic strip programming units are relatively inexpensive and accessible.

In order to overcome certain of the aforementioned drawbacks, a number of device have heretofore been designed which utilize IC-cards (i.e. smart cards) to maintain certain information associated with a customer. For example, retail devices have heretofore been developed which store the total dollar amount of a customer's transaction on a smart card which is issued to the customer. In this manner, the data associated with the customer's transaction (i.e. the total dollar amount) does not have to be stored on a central server associated with the retailer's data network, but rather may be stored on the individual smart cards belonging to the retailer's customers.

However, such a system has a number of additional drawbacks associated therewith. For example, such heretofore designed systems are operable only at the point-of-sale locations (i.e. the checkout terminals) associated with the store. In particular, information from the smart card may only be utilized for retail purposes at the checkout terminals which is often too late to influence customer decision making. As such, the system is not portable and therefore cannot be utilized throughout a customer's shopping experience within the retailer's store.

In an effort to influence customer decision making a various locations throughout the retailer's store, a number of hand-held scanners have been designed which include display screens. As the customer utilizes the scanner to select products, a record of such products is transmitted to the retailer's network via a wireless data communication path. The computing devices associated with the network then selects one or more product advertisements based on the products previously selected by the customer and thereafter transmits an electronic file containing the advertisement back to the scanner. The advertisement is then played for the customer on the scanner's display screen.

However, such scanners are limited in that they may only select advertisements based on products included in the customer's current transaction. Specifically, such a system does not utilize information from previous transactions (e.g. last week's shopping trip) thereby failing to utilize important pieces of marketing information.

What is needed therefore is a method and apparatus for operating a retail system which overcomes one or more of the above-mentioned drawbacks. What is also needed is a method and apparatus for operating a retail system which is portable and may therefore be utilized to influence the purchasing decisions of customers throughout the store. What is moreover needed is a method and apparatus for operating a retail system which is capable of utilizing retail information from previous retail transactions.

### SUMMARY OF THE INVENTION

In accordance with one embodiment of the present invention, there is provided a method of operating retail system having a number of a portable, wireless hand-held computing devices associated therewith. The method includes the step of retrieving retail history information associated with a previous use of the retail system by a customer from a customer profile stored in a card memory device of a smart card. The method also includes the step of operating one of the number of handheld computing devices so as to perform a customer-specific retail function based on the retail history information.

In accordance with another embodiment of the present invention, there is provided a portable, wireless hand-held computing device for use in a retail system. The hand-held computing device includes a smart card interface device which is operable to (i) retrieve information from a card memory device of a smart card, and (ii) transfer information to the card memory device of the smart card. The hand-held computing device also includes a processing unit electrically coupled to the smart card interface device. Moreover, the hand-held computing device includes a unit memory device electrically coupled to the processing unit. The unit memory device has stored therein a plurality of instructions which, when executed by the processing unit, causes the processing unit to (a) operate the smart card interface device so as to retrieve retail history information associated with a previous use of the retail system by a customer from a customer profile stored in a card memory device of a smart card when the smart card is inserted into the smart card interface device, and (b) operate the hand-held computing device so as to perform a customer-specific retail function based on the retail history information.

In accordance with yet another embodiment of the present invention, there is provided a retail system. The retail system includes a smart card for use by a customer. The smart card has a card memory device for maintaining a customer profile associated with the customer. The retail system also includes a retail checkout terminal which includes a first smart card interface device. The first smart card interface device is operable to update the customer profile based on use of the retail checkout terminal by the customer when the smart card is inserted in the first smart card interface device. The retail system yet further includes a portable, wireless hand-held computing device which includes a second smart card interface device. The hand-held computing device is configured to perform a customer-specific retail function based on the customer profile when the smart card is inserted in the second smart card interface device.

It is therefore an object of the present invention to provide a new and useful method and apparatus of operating a portable, wireless handheld computing device.

It is moreover an object of the present invention to provide an improved method and apparatus for operating a portable, wireless handheld computing device.

It is yet further an object of the present invention to provide a method and apparatus for operating a retail system which is portable and may therefore be utilized to influence the purchasing decisions of customers throughout the store.

It is also an object of the present invention to provide a method and apparatus for operating a retail system which is capable of utilizing retail information from previous retail transactions.

The above and other objects, features, and advantages of the present invention will become apparent from the following description and the attached drawings.

### BRIEF DESCRIPTION OF THE DRAWINGS

FIG. 1 is a schematic view of a retail system which incorporates the features of the present invention therein;

FIG. 2 is a simplified block diagram of one of the retail checkout terminals of the retail system of FIG. 1;

FIG. 3 is a simplified block diagram of one of the personal digital assistants of the retail system of FIG. 1; and

FIG. 4 is a simplified block diagram of a smart card which incorporates the features of the present invention therein.

### DETAILED DESCRIPTION OF THE INVENTION

While the invention is susceptible to various modifications and alternative forms, a specific embodiment thereof has been shown by way of example in the drawings and will herein be described in detail. It should be understood, however, that there is no intent to limit the invention to the particular form disclosed, but on the contrary, the intention is to cover all modifications, equivalents, and alternatives falling within the spirit and scope of the invention as defined by the appended claims.

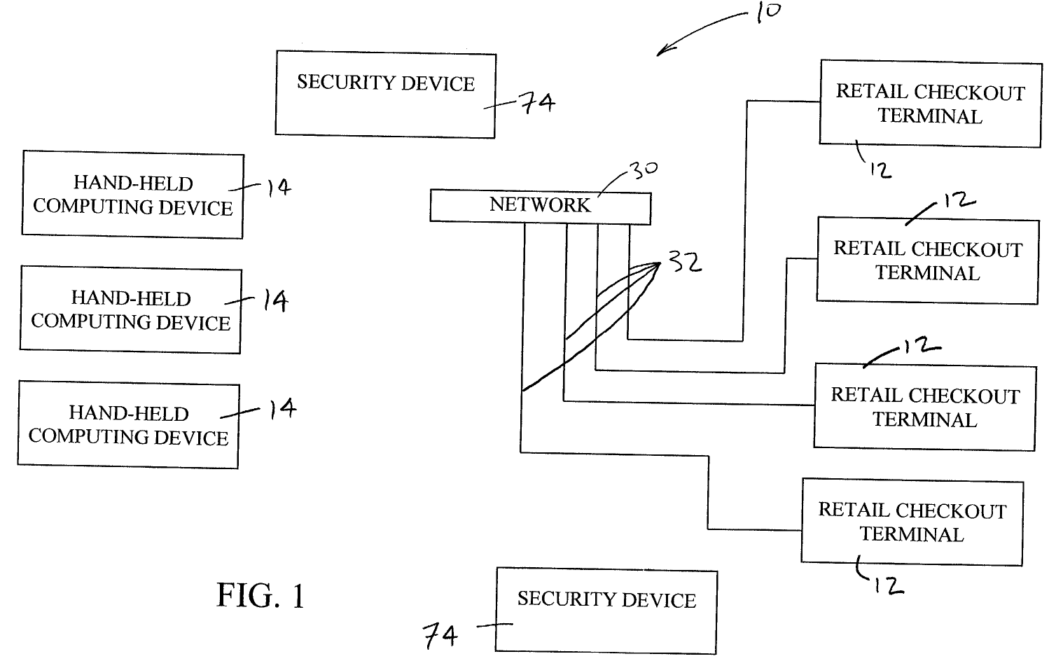

Referring now to FIG. 1, there is shown a retail system 10 for use in a retail business such as a grocery store or department store. The retail system 10 includes a number of checkout terminals 12 and a number of portable, wireless hand-held computing devices 14. The checkout terminals 10 may be embodied as self-service checkout terminals (i.e. retail terminals which are operated by the customer himself or herself without the assistance of retail personnel), assisted checkout terminals (i.e. retail checkout terminals which are operated by a store employee such as a checkout clerk), or any combination thereof. The hand-held computing devices 14 are preferably embodied as known personal digital assistants (PDA's) which, as described in greater detail below, have been modified to include a smart card interface device. For example, the handheld computing devices 14 may take the form of any one of a number of hand-held devices sold under the trade name Palm™ by Palm, Incorporated of Santa Clara, Calif. Additionally, the hand-held computing devices 14 may also take the form of other computing devices such as modified digital cellular telephones or digital watches.

As will be discussed below in greater detail, the retail system 10 of the present invention provides for a customized, user-specific shopping experience for each customer as the customer shops within the retailer's store. In particular, when a customer enters the retailer's store, he or she is assigned or otherwise obtains one of the hand-held computing devices 14. Thereafter, the customer inserts his or her smart card into the smart card interface device associated with the hand-held computing device 14. The processing unit of the hand-held computing device 14 then utilizes the customer-specific information contained on the customer's smart card to perform a number of customized or customer-specific retail functions such as customer-specific advertising in the form of electronic coupons or advertising messages. Moreover, if the customer utilizes a peripheral such as a personal computer or “smart refrigerator” to store an electronic shopping list on his or her smart card prior to arriving at the retailer's store, the contents of the shopping list may be displayed on the hand-held computing device along with advertisements for product brands or the like relating to the items on the list. Once the customer has selected all of his or her items for purchase, the customer advances to one of the retail checkout terminals 12 and thereafter removes his or her smart card from the hand-held computing device 14 and inserts it into the smart card interface device associated with the checkout terminal 12. In such a manner, electronic coupons, voucher, gift certificates, “cash back” offers, or the like stored on the smart card may be redeemed during a checkout transaction. Moreover, a list of the items purchased by the customer may be stored on the smart card by the checkout terminal in order to create a record thereof for use during future visits to the store.

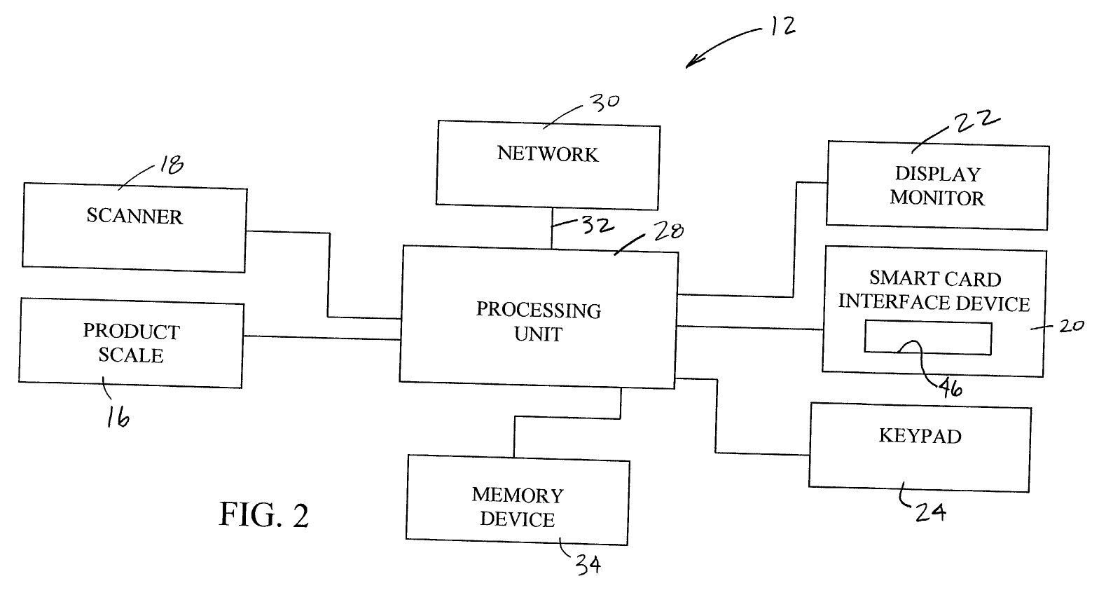

Referring now to FIG. 2, each of the checkout terminals 12 includes, amongst other things, a product scale 16, a scanner 18, a smart card interface device 20, a display monitor 22, a keypad 24, and a processing unit 28. The smart card interface device 20, the display monitor 22, and the keypad 24 may be provided as separate components, or alternatively, may preferably be provided as components of an automated teller machine (ATM).

The scanner 18 conventionally scans or reads a product identification code such as a Universal Product Code (UPC), industrial symbol(s), alphanumeric character(s), or other indicia associated with an item to be purchased. One scanner which may be used as the scanner 18 of the present invention is a model number 7875 bi-optic scanner which is commercially available from NCR Corporation of Dayton, Ohio.

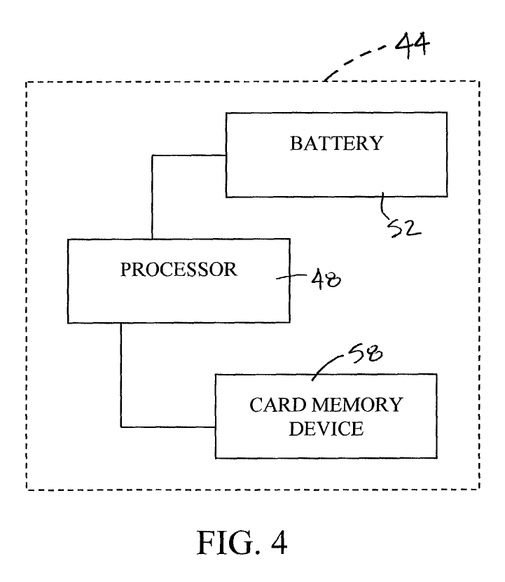

The smart card interface device 20 is provided to download information from, or upload information to, a smart card 44 (see FIG. 4). The smart card 44 may be inserted into a slot 46 of the smart card interface device 20 in order to be electrically coupled to the smart card interface device 20. In particular, the smart card interface device 20 includes electrical contacts (not shown) which correspond to electrical contacts (not shown) on the smart card 44 so as to allow communication between the smart card interface device 20 and the smart card 44 when the smart card 44 is positioned in the slot 46.

The processing unit 28 includes network interface circuitry (not shown) which conventionally permits the self-service checkout terminal 10 to communicate with a network 30 such as a LAN or WAN through a wired connection 32. The processing unit 28 communicates with the network 30 during the checkout procedure in order to obtain information such as pricing information associated with an item being scanned or otherwise entered, and also to verify customer credit approval when appropriate. The network interface circuitry associated with the retail checkout terminal 12 may include a known Ethernet expansion card, and the wired connection 32 may include a known twisted-pair communication line. Alternatively, the network interface circuitry may support wireless communications with the network 30.

The processing unit 28 is electrically coupled to a memory device 34. The memory device 34 is provided to maintain a number of databases associated with operation of the retail system 10. For example, the memory device 34 maintains an electronic transaction table which includes a record of the product information associated with each item that is scanned, weighed, or otherwise entered during the customer's operation of the retail checkout terminal 10. For example, if the customer scans a can of soup, the product identification number, the description of the soup, and the pricing information associated therewith is recorded in the transaction table in the memory device 34. Similarly, if the customer weighs a watermelon with the product scale 16 and then enters a product lookup code associated with watermelon via the keypad 24, product information associated with the watermelon is recorded in the transaction table. Moreover, if a customer enters a coupon or voucher, the information associated therewith would also be recorded in the transaction table.

It should therefore be appreciated that the sum of each of the items recorded in the transaction table (1) minus any reductions (e.g. coupons), and (2) plus any applicable taxes is the amount that the customer pays for his or her transaction. Moreover, data stored in the transaction table is printed out on a printer (not shown) associated with the terminal 12 thereby generating a receipt for the customer at the end of his or her transaction. Yet further, it should also be appreciated that a copy of the data stored in the transaction table is transferred to a card memory device 58 of the smart card 44 (see FIG. 4) in order to generate a similar transaction table (or a summary of the transaction table) in the card memory device 58 thereby generating retail history information such as purchase history information in the form of an electronic record of the customer's transaction.

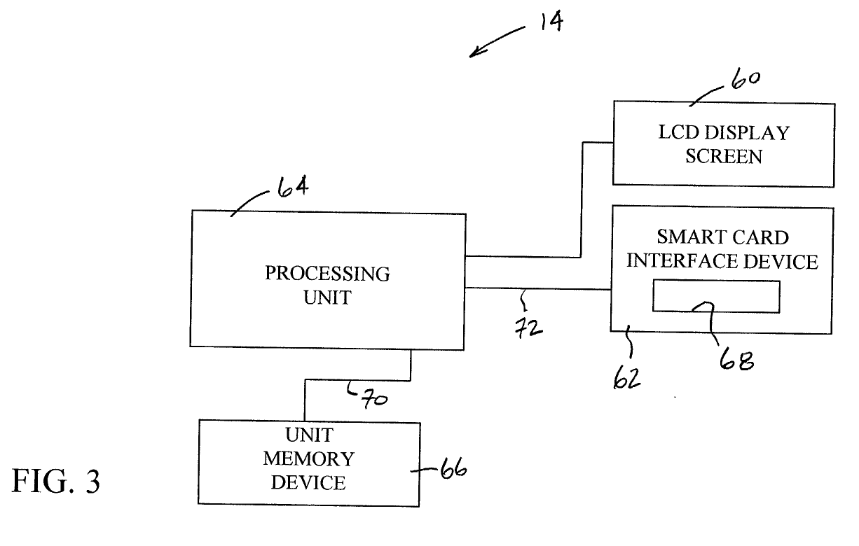

As shown in FIG. 3, each of the hand-held computing devices 14 includes a display screen 60, a smart card interface device 62, a processing unit 64, and a unit memory device 66. As with the smart card reader device 20 of the checkout terminal 10, the smart card interface device 62 is provided to download information from, or upload information to, the smart card 44 (see FIG. 4). Specifically, the smart card 44 may be inserted into a slot 68 of the smart card interface device 20 in order to be electrically coupled to the smart card interface device 20. In particular, the smart card interface device 62 includes electrical contacts (not shown) which correspond to electrical contacts (not shown) on the smart card 44 so as to allow communication between the smart card interface device 62 and the smart card 44 when the smart card 44 is positioned in the slot 68.

The smart card interface device 62 may be any known commercially available, portable smart card interface device . On such commercially available smart card interface device which may be used as the smart card interface device 62 of the present invention, with slight modification thereof, is either a model number 844 or a model number 846 Chipcard-Acceptor which is commercially available from Giesecke & Devrient America, Incorporated of Reston, Va.

As indicated above, the hand-held computing device 14 includes a display screen 60 such as a liquid-crystal display (LCD). The display screen 60 is utilized to display retail information. For example, the display screen 60 may be utilized to display a visual representation of a product advertisement or a shopping list. Moreover, the display screen 60 is preferably configured as a touch-screen device which allows a user to enter data by touching a predetermined portion of the display screen 60 with either his or her finger or a stylus device (not shown).

The processing unit 64 of the hand-held computing device 14 is coupled to the unit memory device 66 via a data communication line 70. The unit memory device 66 maintains the operational and application software utilized to operate the hand-held memory device 14 in the manner hereinafter described. Moreover, the processing unit 64 is electrically coupled to the smart card interface device 62 via a data interface 72. In such a manner, data may be transmitted between the processing unit 64 of the hand-held computing device 14 and the processor of the smart card 44 via the data interface 72.

As shown in FIG. 4, the smart card 44 includes a processor 48, a battery 52, and the card memory device 58. The processor 48 is electrically coupled to the battery 52 so as to provide power to the processor 48 and the card memory device 58. The processor 48 is electrically coupled to the card memory device 58 via a data communication line so as to selectively allow data to be stored in or received from the card memory device 58 when the smart card 44 is positioned in one of the smart card interface devices 20, 62. The smart card 44 of the present invention may be embodied as the smart card disclosed in U.S. Pat. No. 5,727,153 issued to Powell or any other commercially available smart card which has the hardware and software configuration to fit the needs of a given retail system such as a Cyberflex 16K Smart Card which is commercially available from Schlumberger Industries of Moorestown, N.J.

The card memory device 58 maintains a customer profile of the customer to which the smart card 44 is assigned. In particular, the card memory device 58 has stored therein a customer profile which includes information such as the demographic information (e.g. name, address, age, income level, etc.) associated with the customer to which the smart card 44 was issued. It should be appreciated that such demographic information may be collected by the retailer and thereafter stored in the card memory device 58 when the customer initially registers or otherwise procures the smart card 44 from the retailer. Such demographic information is generally useful to a retailer in determining the buying habits of particular groups of customers. For example, the retailer may desire to know the dollar amount of a particular type of product that the retailer sells to a particular age group. Moreover, the retailer may wish to monitor the home addresses of its customers in order to determine the appropriate advertising range needed in order to adequately reach the retailer's customers.

The customer profile stored in the card memory device 58 of the smart card 44 also includes retail history information associated with the customer's previous use of the retail system 10. What is meant herein by the term “retail history information” is information associated with a given customer's previous shopping experiences, transactions, and/or purchases from the retailer's operation. Examples of retail history information include the number of times the customer has shopped in the retailer's store or stores in a given time period (e.g. the previous six months), the dollar amount spent by the customer in a given time period, a list of each of the items purchased by the customer during a given time period, a list of each of the items that the customer inquired about while operating a kiosk or the like within the retailer's store, etcetera. What is meant herein by the phrase “previous use” is a prior retail session by a given customer in which the customer activated or otherwise “logged on” one of the retail devices (e.g. a retail checkout terminal 12, a hand-held computing device 14, a kiosk, etcetera), completed a retail transaction or inquiry, and thereafter deactivated or otherwise “logged off” the retail device. For example, if a customer checked out his or her items for purchase by use of the retail checkout terminal 12 during the customer's visit to the retailer's store last week, such previous operation of the retail checkout terminal 12 would be a previous use by the customer. Moreover, if a customer utilized one of the hand-held computing devices 14 to lookup information relating to an item for purchase that the customer was interested in during the customer's visit to the retailer's store last week, such previous use of the hand-held computing device 14 would be a previous use by the customer.

Hence, prior to completing a retail checkout transaction with one of the retail checkout terminals 12, a transaction table or list of the customer's items for purchase is stored in the card memory device 58 of the smart card 44. In particular, during operation of the retail checkout terminal 12, the customer is instructed to insert his or her smart card 44 into the slot 46 of the smart card interface device 20. In such a manner, the smart card interface device 20 may be utilized to transmit a data to the smart card 44 for the purpose of compiling a transaction list of the items purchased by the customer in the card memory device 58. Such a list serves as a record of the customer's previous purchases.

It should be appreciated that such a list of previous purchases may be utilized in the administration of a customer loyalty program. In particular, an important component of a customer loyalty program is a record of the customer's previous purchasing habits from the retailer's store or stores. Hence, by maintaining an electronic list of the customer's previously purchased items, the retailer may utilize such information in order to reward loyal customers who spend relatively large dollar amounts at the retailer's store, or who purchase items with relatively large profit margins, or who fit any other criteria as established by the retailer.

Moreover, the retailer may utilize the electronic list of the customer's previously purchased items stored in the card memory device 58 in order to perform a customer-specific retail function with the one of the hand-held computing devices 14. What is meant herein by the term “customer-specific retail function” is a retail function which is customized for a given customer based on the purchasing habits, demographic information, or some other information which is unique to the customer. For example, the retailer may analyze the customer's electronic list in order to determine a specific item or item-type which the customer frequently purchases. Thereafter, the retailer may then store an electronic coupon relating to the specific item or item type in the card memory device 58 of the customer's smart card 44 in order to encourage the customer to purchase additional items. For instance, if, while the customer's smart card 44 is positioned in the smart card interface device 62 of the hand-held computing device 14, the processing unit 64 of the hand-held computing device 14 determines from an analysis of the electronic list stored on the customer's smart card 44 that the customer frequently purchases soda when shopping at the retailer's store, an electronic coupon for soda or a related item (e.g. pretzels) may be stored on the customer's smart card 44 in order to entice the customer to purchase soda or the related item.

As a further example of a customer-specific retail function, the retailer may configure the hand-held computing device 14 to store an electronic gift certificate on the customer's smart card 44 based on the analysis of the electronic list stored in the card memory device 58. In particular, if the customer has spent (within a given time period) a dollar amount greater than or equal to a predetermined dollar amount, the retailer may configure the hand-held computing device 14 such that an electronic gift certificate is stored in the card memory device 58 of the customer's smart card 44. Thereafter, the customer may redeem the electronic gift certificate for merchandise from the customer's store.

Yet a further example of a customer specific retail function may include displaying a customized advertising message on the display screen 60 of the hand-held computing device 14 based on the analysis of the electronic list stored it the card memory device 58 of the smart card 44. For instance, if, while the customer's smart card 44 is positioned in the smart card interface device 62 of the hand-held computing device 14, the processing unit 64 of the hand-held computing device 14 determines from an analysis of the electronic list stored on the customer's smart card 44 that the customer frequently purchases soda when shopping at the retailer's store, an advertising message for soda or a related item (e.g. pretzels) may be displayed on the display screen 60 of the hand-held computing device 14 in order to entice the customer to purchase soda or the related item. It should be appreciated that if the hand-held computing device 14 is configured to include audio capabilities, a corresponding audio portion of the advertising message may be played along with the video portion that is displayed on the display screen 60.

Moreover, as alluded to above, an electronic shopping list may be stored in the card memory device 58 of the smart card 44 by the customer prior to arriving at the retailer's store. The customer may create such a list at home on his or her personal computer or may compile such a list by the use of other devices such as a “smart refrigerator” (which may be operated to track items removed therefrom). In any event, if the customer places an electronic shopping list on his or her smart card 44 prior to arriving at the retailer's store, the contents of the list may be read from the card 44 and thereafter displayed on the display screen 60 of the card for use by the customer. The processing unit 64 of the hand-held computing device 14 may utilize the contents of the list to perform a customer-specific retail function such as storing an electronic coupon relating to a specific brand of one of the items on the list. An advertisement for a specific brand of one of the items may be displayed on the display screen 60. Moreover, a path or map of the retailer's store may be generated on the display screen 60 which directs the customer through the store in an efficient manner in order to allow the customer to quickly select each of the items on his or her list. Such a path or map may be “manipulated” in order to direct the customer to certain products or “specials” which relate to one or more of the items on the customer's list.

As shown in FIG. 1, the retail system 10 also includes a number of security devices 74. The security devices 74 are provided to protect the retailer from inadvertent, or even intentional, removal of the hand-held computing devices 14 from a predetermined area. Specifically, the security devices 74 are provided to prevent removal of the hand-held computing devices from the retailer's store. In order to do so, an electronic article surveillance (EAS) tag may be applied to each of the hand-held computing devices 14. Each of the entrances and exits to the retailer's store may be equipped with detection equipment such that if a customer attempts to remove one of the hand-held computing devices 14 from the store, an alarm or the like is activated so as to alert retail personnel (e.g. security personnel). It should be appreciated that the detection equipment may be the same detection equipment which is currently in use in many retail stores to prevent theft of items for purchase. In such a manner, the hand-held computing devices 14 would be equipped with a compatible EAS tag much in the same way that articles of merchandise are tagged in the retailer's store thereby eliminating the need to install a dedicated security system for the hand-held computing devices 14. It should also be appreciated that the smart card 44 itself is not equipped with such an EAS tag thereby allowing the smart card (if removed from the hand-held computing device 14) to be freely taken into and out of the retailer's store.

### Operation of the Present Invention

In operation, the retail system 10 of the present invention may be utilized to provide a customized shopping experience to a customer throughout his or her entire shopping experience with the retailer's store. In particular, when a customer enters the retailer's store, he or she is assigned or otherwise obtains one of the hand-held computing devices 14. Thereafter, the customer is instructed to insert his or her smart card 44 into the card slot 68 of the smart card interface device 62 associated with the hand-held computing device 14. The processing unit 64 of the hand-held computing device 14 then accesses the customer-specific information contained in the customer profile in the card memory device 58 on the customer's card 44.

As discussed above, such customer-specific information may include retail history information such as the number of times the customer has shopped in the retailer's store or stores in a given time period (e.g. the previous six months), the dollar amount spent by the customer in a given time period, purchase history information in the form of a list of each of the items purchased by the customer during a given time period, a list of each of the items that the customer inquired about while operating a kiosk or the like within the retailer's store, etcetera. The customer-specific information from the customer's card 44 may also include demographic information about the customer.

In any event, once the processing unit 64 of the hand-held computing device 14 has accessed the customer profile stored in the card memory device 58 of the customer's card 44, the processing unit 64 utilizes the information contained therein to perform a number of customized or customer-specific retail functions. For example, the information contained in the customer's profile may be utilized to generate customer-specific advertising in the form of electronic coupons or gift certificates which are stored in the card memory device 58 on the customer's card 44 for subsequent redemption during a checkout procedure. The information contained in the customer's profile may also be utilized to generate customized advertising messages relating to products which the customer has purchased in the past or inquired about in the past.

As described above, the retailer may configure the software associated with the hand-held computing device 14 to perform such customer-specific retail functions based on any desired criteria. For example, a given brand of product may be selected to be included in an electronic coupon or advertisement by any manner or criteria. For instance, a particular type of product or brand of product may be selected if the customer has previously purchased an identical type of product or brand of product. Moreover, the a particular type of product or brand of product may be selected for use in a customized function if the customer has previously purchased related products (e.g. a pretzel advertisement may be displayed if the customer frequently buys other snacks or soda). In addition, the customer's demographic information may be utilized in the selection of a particular product or service to be advertised to the customer (e.g. an advertisement message for men's aftershave would likely not be displayed to a female shopper).

Moreover, if the customer utilizes a peripheral such as a personal computer or “smart refrigerator” to load an electronic shopping list into the card memory device 58 of the customer's card 44 prior to arriving at the retailer's store, the contents of the shopping list may be displayed on the display screen 60 of the hand-held computing device 14 during the customer's visit to the store. Moreover, advertisements relating to product brands of the items on the list may also be displayed. The processing unit 64 of the hand-held computing device 14 may also utilize the contents of the shopping list to generate and thereafter display a path or map of the retailer's store which guides the customer through the store in a manner which takes the customer to the location of each of his or her desired items. Such a path or map may be manipulated to direct the customer to desired locations which contain, for example, promotional items related to one or more of the items on the customer's list.

Once the customer has selected all of his or her items for purchase, the customer advances to one of the retail checkout terminals 12. The customer then removes his or her smart card 44 from the smart card interface device 62 of the hand-held computing device 14 and thereafter inserts the card 44 into the card slot 46 of the smart card interface device 20 associated with the checkout terminal 12. The processing unit 28 of the checkout terminal 12 then accesses the card memory device 58 of the customer's card 44 in order to determine if any applicable electronic “tokens” are present. In particular, the processing unit 28 determines if any electronic coupons, voucher, gift certificates, “cash back” offers, or the like are stored on the customer's smart card 44. If such an electronic token is present, the smart card interface device 20 is operated so as to download or otherwise remove the token from the card memory device 58 of the customer's card 44 and thereafter credits the customer's transaction with the same during completion of the customer's checkout transaction.

Moreover, near the completion of the checkout transaction, a list of the items purchased by the customer may be stored in the customer's profile on his or her smart card 44 in order for such information to be available for use by the hand-held computing devices 14 during a future visit to the store by the customer. Moreover, any other relevant information (e.g. total dollar amount, types of coupons redeemed, answers to any survey questions asked by the checkout terminal 12, etcetera) are also stored on the customer's card prior to completion of the checkout transaction. Once the checkout transaction is complete and all desired information has been stored in the card memory device 58 of the customer's card 44, the processing unit 28 instructs the smart card interface device 20 to eject or otherwise return the customer's card 44 thereby completing the checkout transaction.

Hence as described herein, utilizing the customer's smart card 44 to maintain retail history information for use in administration of a customer-specific retail program such as a customer loyalty program or a customer-specific marketing program has numerous advantages over systems and methods which have heretofore been designed. For example, utilizing the customer's smart card to maintain retail history information advantageously eliminates the need to maintain a network computing device and associated large data storage device for the purpose of maintaining such information for each of the retailer's customers on the retailer's network. Moreover, use of a smart card provides a relatively high security level against fraud since commercially available smart cards are generally configurable with elaborate encryption schemes to prevent fraudulent use thereof. In addition, by utilizing the hand-held computing devices, the information contained in the smart card may be utilized to generate customer-specific messages within all of the shopping areas of the store thereby allowing the customer to be “influenced” at the decision making points in the store (as opposed to only at the retail checkout terminal).

While the invention has been illustrated and described in detail in the drawings and foregoing description, such an illustration and description is to be considered as exemplary and not restrictive in character, it being understood that only the preferred embodiment has been shown and described and that all changes and modifications that come within the spirit of the invention are desired to be protected.

There are a plurality of advantages of the present invention arising from the various features of the retail system described herein. It will be noted that alternative embodiments of the retail system of the present invention may not include all of the features described yet still benefit from at least some of the advantages of such features. Those of ordinary skill in the art may readily devise their own implementations of a retail system that incorporate one or more of the features of the present invention and fall within the spirit and scope of the present invention as defined by the appended claims.

For example, although each of the hand-held computing devices 14 has been described herein as having a smart card interface device 60, and has significant advantages thereby in the present invention, it should be appreciated that certain of such advantages may be achieved by other configurations. For example, the rack, shelf, or other receptacle on which the hand-held computing devices 14 are stored may have a single, centralized smart card interface device associated therewith which is electrically coupled to an I/O port of each of the hand-held computing devices 14 via a wiring harness and connector assembly (not shown). In such a manner, the customer may utilize the centralized card interface device to download the information contained in the card memory device 58 of the customer's card 44 prior to removal of the hand-held computing device 14 from its storage receptacle. Thereafter, any additional retail history information generated by the customer's use of the hand-held computing device 14 may be temporarily stored in the unit memory device 66 of the hand-held computing device 14 and thereafter uploaded to the card memory device 58 of the customer's card 44 by replacing the customer's card in the centralized card reader interface device upon return of the hand-held computing device 14 to its storage receptacle. Such a system advantageously reduces the costs associated with each hand-held computing device 14 since it would not be necessary to equip each device 14 with a smart card interface device.

As a further example, it should be appreciated that each of the hand-held computing devices may be equipped with a wireless communication device which allows for wireless communication with the retailer's network 30. In such a manner, the retailer may communicate “live” messages to the customer such as directions to a particular store location or real-time customized advertising messages.

For further example, the smart card 44 may be utilized to track purchases based on the gross margin return associated with a given customer's items for purchase. In particular, each item purchased by the customer has a profit margin associated therewith which may be tracked in order to reward the customer if he or she is consistently purchasing items with relatively high profit margins. For example, the smart card 44 may be utilized to track the number or dollar amount of items which have (1) a negative profit margin (e.g. loss leaders), (2) a relatively low (less than 1% or even zero) profit margin, (3) a profit margin of 2-4%, (4) a profit margin of 4-5%, and (5) a profit margin of greater than 5%. The customer may then be rewarded (e.g. given an electronic coupon or gift certificate) when his or her purchases of a given profit margin range exceed a predetermined amount. Alternatively, it should be appreciated that the profit margin associated with the customer's entire transaction may also be tracked in a similar manner if the smart card 44 is so utilized.

What is claimed is:

1. A method of operating retail system having a number of a portable, wireless hand-held computing devices associated therewith, comprising the steps of:
retrieving retail history information associated with a previous use of said retail system by a customer from a customer profile stored in a card memory device of a smart card; and
operating one of said number of hand-held computing devices so as to perform a customer-specific retail function based on said retail history information.

2. The method of claim 1, wherein:
each of said number of hand-held computing devices includes a smart card interface device which is operable to (i) retrieve information from said card memory device of said smart card, and (ii) transfer information to said card memory device of said smart card, and
said retrieving step includes the step of retrieving said retail history information associated with said previous use of said retail system by said customer from said customer profile stored in said card memory device of said smart card when said smart card is inserted into said card interface device of said one of said number of hand-held computing devices.

3. The method of claim 1, wherein:
said retail system further includes a number of retail checkout terminals,
said retail history information associated with said previous use of said retail system by said customer includes purchase history information associated with a previous use of one of said number of retail checkout terminals by said customer,
said retrieving step includes the step of retrieving said purchase history information from said card memory device of said smart card, and
said operating step includes the step of operating said one of said number of hand-held computing devices so as to perform said customer-specific retail function based on said purchase history information.

4. The method of claim 1, wherein said step of operating said one of said number of hand-held computing devices so as to perform said customer-specific retail function includes the step of storing an electronic coupon in said card memory device of said smart card based on said retail history information.

5. The method of claim 1, further comprising the steps of:
retrieving an electronic shopping list from said card memory device of said smart card; and
generating a message with said hand-held computing device based on said electronic shopping list.

6. The method of claim 1, wherein said step of operating said one of said number of hand-held computing devices so as to perform said customer-specific retail function includes the step of generating a customer-specific advertisement message with said hand-held computing device based on said retail history information.

7. The method of claim 1, further comprising the step of retrieving demographic information associated with a customer from said customer profile stored in said card memory device of said smart card, wherein said operating step includes the step of operating said one of said number of hand-held computing devices so as to perform said customer-specific retail function based on both said retail history information and said demographic information.

8. A portable, wireless hand-held computing device for use in a retail system, comprising:
a smart card interface device which is operable to (i) retrieve information from a card memory device of a smart card, and (ii) transfer information to said card memory device of said smart card;
a processing unit electrically coupled to said smart card interface device; and
a unit memory device electrically coupled to said processing unit, wherein said unit memory device has stored therein a plurality of instructions which, when executed by said processing unit, causes said processing unit to:
(a) operate said smart card interface device so as to retrieve retail history information associated with a previous use of said retail system by a customer from a customer profile stored in a card memory device of a smart card when said smart card is inserted into said smart card interface device; and
(b) operate said hand-held computing device so as to perform a customer-specific retail function based on said retail history information.

9. The hand-held computing device of claim 8, wherein:
said retail history information associated with said previous use of said retail system by said customer includes purchase history information associated with a previous use of a retail checkout terminal of said retail system by said customer, and
said plurality of instructions, when executed by said processing unit, further causes said processing unit to (a) operate said smart card interface device so as to retrieve said purchase history information from said card memory device of said smart card, and (b) operate said handheld computing device so as to perform said customer-specific retail function based on said purchase history information.

10. The hand-held computing device of claim 8, wherein said plurality of instructions, when executed by said processing unit, further causes said processing unit to store an electronic coupon in said card memory device of said smart card based on said retail history information.

11. The hand-held computing device of claim 8, wherein said plurality of instructions, when executed by said processing unit, further causes said processing unit to (a) retrieve an electronic shopping list from said card memory device of said smart card, and (b) generate a message with said hand-held computing device based on said electronic shopping list.

12. The hand-held computing device of claim 8, wherein said plurality of instructions, when executed by said processing unit, further causes said processing unit to generate a customer-specific advertisement message with said hand-held computing device based on said retail history information.

13. The hand-held computing device of claim 8, wherein said plurality of instructions, when executed by said processing unit, further causes said processing unit to:
(a) retrieve demographic information associated with a customer from said customer profile stored in said card memory device of said smart card, and
(b) operate said hand-held computing device so as to perform said customer-specific retail function based on both said retail history information and said demographic information.

14. A retail system, comprising:
a smart card for use by a customer, said smart card having a card memory device for maintaining a customer profile associated with said customer;
a retail checkout terminal which includes a first smart card interface device, said first smart card interface device is operable to update said customer profile based on use of said retail checkout terminal by said customer when said smart card is inserted in said first smart card interface device; and
a portable, wireless hand-held computing device which includes a second smart card interface device, said hand-held computing device being configured to perform a customer-specific retail function based on said customer profile when said smart card is inserted in said second smart card interface device.

15. The retail system of claim 14, wherein said second smart card interface device is operable to update said customer profile based on use of said hand-held computing device by said customer when said smart card is inserted in said second smart card interface device.

16. The retail system of claim 14, wherein said hand-held computing device is further configured to store an electronic coupon in said card memory device of said smart card based on said retail history information.

17. The retail system of claim 14, wherein said hand-held computing device is further configured to (i) retrieve an electronic shopping list from said card memory device of said smart card, and (ii) generate a message with said hand-held computing device based on said electronic shopping list.

18. The retail system of claim 14, wherein said hand-held computing device is further configured to generate a customer-specific advertisement message based on said retail history information.

19. The retail system of claim 14, wherein:
said second smart card interface device is further operable to retrieve demographic information associated with said customer from said customer profile stored in said card memory device of said smart card, and
said hand-held computing device is further configured to perform said customer-specific retail function based on both said retail history information and said demographic information.

20. The retail system of claim 14, further comprising a security device, wherein:
said security device is configured to prevent removal of said handheld computing device from a predetermined area, and
said security device is further configured to allow removal of said smart card from said predetermined area.
